(19) United States
(12) Patent Application Publication
(10) Pub. No.: US 2013/0265414 A1
(43) Pub. Date: Oct. 10, 2013

(54) VEHICLE CRASH PREVENTION APPARATUS AND METHOD

(71) Applicants: Sanghun Yoon, Daejeon (KR); Jung Hee Suk, Daejeon (KR); Chun-Gi Lyuh, Daejeon (KR); Ik Jae Chun, Daejeon (KR); Tae Moon Roh, Daejeon (KR); Jaechang Shim, Gyeongsangbuk-do (KR); Wookjin Chung, Gyeongsangbuk-do (KR); Yeunghak Lee, Daegu (KR)

(72) Inventors: Sanghun Yoon, Daejeon (KR); Jung Hee Suk, Daejeon (KR); Chun-Gi Lyuh, Daejeon (KR); Ik Jae Chun, Daejeon (KR); Tae Moon Roh, Daejeon (KR); Jaechang Shim, Gyeongsangbuk-do (KR); Wookjin Chung, Gyeongsangbuk-do (KR); Yeunghak Lee, Daegu (KR)

(73) Assignees: Anadong National University Industry-Academic Cooperation Foundation, Gyeongdangbuk-do (KR); Electronics and Telecommunications Research Institute, Daejeon (KR)

(21) Appl. No.: 13/994,918

(22) PCT Filed: Dec. 15, 2011
(86) PCT No.: PCT/KR2011/009668

§ 371 Date: Jun. 17, 2013

(30) Foreign Application Priority Data
Dec. 17, 2010 (KR) 10-2010-0129856

(51) Int. Cl. G08G 1/16

(52) U.S. Cl. CPC G08G 1/161
USPC 348/118; 382/105

(57) ABSTRACT

The present invention relates to a vehicle accident prevention apparatus comprising a camera unit which photographs an image of a front view, an image recognition unit which processes the image of the front view to detect the registration number of a vehicle driving in front of the vehicle from a license plate of the vehicle driving in front of the vehicle, a wireless communication unit which receives accident prevention information containing an identifier and speed of the vehicle driving in front of the vehicle, a speed sensing unit which senses the speed of the vehicle equipped with the apparatus of the present invention, and a determining and control unit which identifies the vehicle driving in front of the vehicle by matching the registration number and the identifier of the vehicle driving in front of the vehicle, and generates a control signal for preventing vehicle accident by performing a speed comparison.

### TECHNICAL FIELD

The present invention relates to an accident prevention system, and more particularly, to a vehicle accident prevention apparatus and method for preventing an accident with a leading vehicle while driving.

### BACKGROUND ART

Numerous post accident safety devices are available for minimizing injuries to a driver, such as, a seat belt or an airbag, due to various accidents that may occur while driving. However, earnest research into preventing vehicular accidents is being conducted in order to predict accidents while driving.

A first such attempt may include apparatuses for determining conditions of an accident with a leading vehicle, through transmitting a radar signal or a laser signal in a forward direction and receiving a reflected signal. However, an accuracy of such attempts may differ in terms of determining an accident, based on whether a vehicle is being driven on a straight road or a curved road, and only determine distance information between vehicles.

A driver of a vehicle while driving on a road, for example, a highway, and the like, may be unable to accurately gauge a driving speed of a leading vehicle. Information for determining a driving condition of the leading vehicle may need to be provided because a driver driving at night may experience difficulty in direct recognition of a driving state of a leading vehicle, for example, a high speed driving state, a low speed driving state, or an idle state. In particular, a braking distance and an idle running distance may need to be minimized to prevent an accident in an emergency braking situation of the leading vehicle, and the like.

However, existing apparatuses for determining a condition of an accident may have an issue in that an error may occur in determining an accident prevention with a leading vehicle because relative speed information based on driving of the leading vehicle may not be obtained by providing distance information with the leading vehicle.

### DISCLOSURE OF INVENTION

### Technical Goals

An aspect of the present invention provides a vehicle accident prevention apparatus and method that prevents an accident between vehicles.

Another aspect of the present invention provides a vehicle accident prevention apparatus and method that minimizes an error in determining accident prevention.

### Technical Solutions

According to an aspect of the present invention, there is provided a vehicle accident prevention apparatus, including a camera unit to photograph a front image of a vehicle, an image recognition unit to recognize a leading vehicle registration number from a license plate of the leading vehicle located at a front of the vehicle, through image processing of the front image, a wireless communication unit to receive accident prevention information including a leading vehicle identifier and a speed of the leading vehicle, through communicating with the leading vehicle, a speed detection unit to detect a speed of the vehicle, and a determining and control unit to identify the leading vehicle, through matching the leading vehicle registration number and the leading vehicle identifier, and generate a control signal for preventing an accident with the leading vehicle through comparing the speed of the vehicle to the speed of the leading vehicle.

The vehicle accident prevention apparatus may further include a global position system (GPS) module unit to measure a time of the vehicle.

The determining and control unit may receive the time of the leading vehicle through the wireless communication unit, and compare the speed of the vehicle to the speed of the leading vehicle at a point of time at which a time of the leading vehicle and a time of the vehicle match.

The image measurement unit may recognize the license plate of the leading vehicle through the photographed image, and generate distance information between the leading vehicle and the vehicle through a number of pixels of the recognized license plate.

The determining and control unit may generate the control signal, using the measured distance information.

The vehicle accident prevention apparatus may further include a driver control unit to control a braking device of the vehicle through receiving the control signal.

The driver control unit may receive the control signal, and emit an alert signal to a driver of the vehicle.

The wireless communication unit may receive an alert signal, from the leading, vehicle for preventing the accident.

The determining and control unit may generate a control signal for preventing an accident with the leading vehicle, based on the alert signal of the leading vehicle.

The determining and control unit may receive accident prevention information from the leading vehicle or other vehicles being driven in front of the vehicle, and generate information on an arrangement of vehicles in a vicinity of the vehicle, based on the accident prevention information.

The wireless communication unit may set a communication channel for exclusive communication with the leading vehicle.

The determining and control unit may generate information on an arrangement of vehicles in a lane in which a vehicle is being driven when information about other leading vehicles located in front of the leading vehicle, in a lane in which the leading vehicle is being driven, and output the generated information on the arrangement of vehicles to a display device.

According to an aspect of the present invention, there is provided a vehicle accident prevention method, including recognizing a license plate of a leading vehicle included in a photographed image of a front of a vehicle, receiving a leading vehicle identifier and a speed of the leading vehicle from the leading vehicle, identifying the leading vehicle through matching a leading vehicle registration number obtained from the license plate of the leading vehicle and the leading vehicle identifier, measuring a speed of the vehicle, and generating a control signal for preventing an accident with the leading vehicle through comparing the speed of the leading vehicle to the speed of the vehicle.

The recognizing of the license plate of the leading vehicle may include recognizing a lane included in the photographed image, recognizing a leading vehicle in the lane, and recognizing a license plate of a vehicle when the recognized leading vehicle is a vehicle located in a lane identical to a lane in which a vehicle is currently being driven.

The vehicle accident prevention method may further include displaying an accident alert state, based on the control signal.

The vehicle accident prevention method may further include controlling a braking device of the vehicle, based on the control signal.

The vehicle accident prevention method may further include receiving information about other leading vehicles located in a lane identical to a lane of the leading vehicle, generating information on an arrangement of vehicles including the leading vehicle and the other leading vehicles, and displaying the information on the arrangement of vehicles.

### Effects of Invention

According to an aspect of the present invention, a vehicle accident prevention apparatus may minimize an error probability in determining vehicle accident prevention, through obtaining relative speed information of a leading vehicle.

### BRIEF DESCRIPTION OF DRAWINGS

FIG. 1 is a diagram illustrating a structure of a vehicle accident prevention apparatus according to example embodiments.

FIG. 2 is a diagram illustrating an operation of preventing a vehicle accident in a vehicle accident prevention apparatus according to example embodiments.

FIG. 3 is a diagram illustrating an operation of transmitting accident prevention information for preventing a vehicle accident in a vehicle accident prevention apparatus according to example embodiments.

FIG. 4 is a diagram illustrating an operation of transmitting accident prevention information for preventing an accident with another vehicle in a vehicle accident prevention apparatus according to example embodiments.

FIG. 5 is a diagram illustrating a wireless communication area of a vehicle to which a vehicle accident prevention apparatus is attached according to example embodiments.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

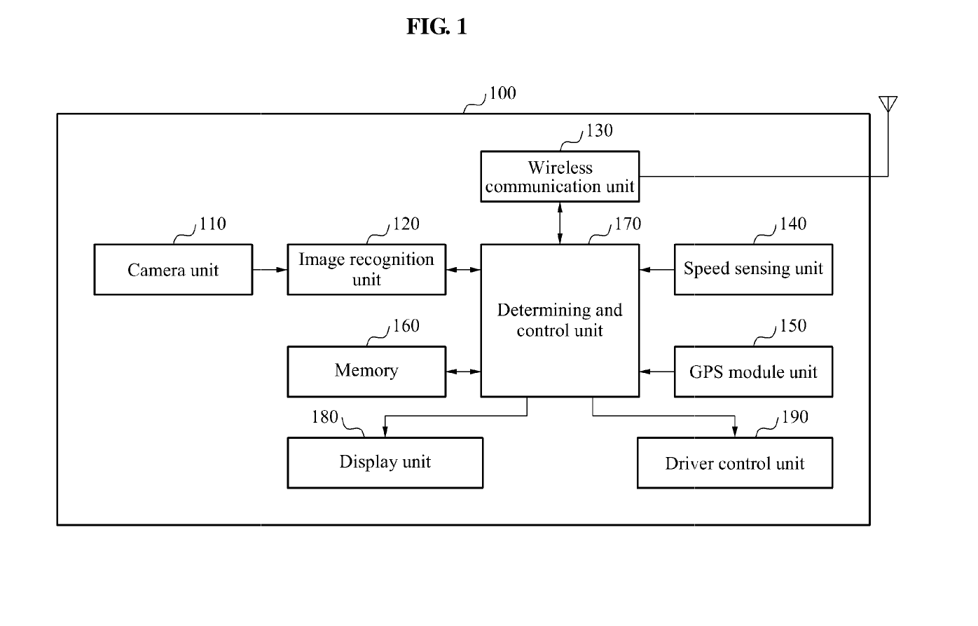

FIG. 1 is a diagram illustrating a structure of a vehicle accident prevention apparatus 100 according to example embodiments.

Referring to FIG. 1, the vehicle accident prevention apparatus 100 may include a camera unit 110, an image recognition unit 120, a wireless communication unit 130, a speed detection unit 140, a global position system (GPS) module unit 150, a memory 160, a determining and control unit 170, a display unit 180, and a driver control unit 190. The vehicle accident prevention apparatus 100 may be provided on a moving instrument including a vehicle.

The camera unit 110 may include cameras for photographing an image. The camera unit 110 may include a camera for photographing a front image, according to a driving of a vehicle. Also, the camera unit 110 may include a camera for photographing a rear image of a vehicle. The image photographed via a camera may include a lane, a leading vehicle, and a rear vehicle. Here, the leading vehicle may refer to a vehicle at a front of a vehicle provided with the vehicle accident prevention apparatus 100, and the rear vehicle may refer to a vehicle at a rear of a vehicle provided with the vehicle accident prevention apparatus 100.

The camera unit 110 may output a front image or a rear image photographed by the image recognition unit 120.

The image recognition unit 120 may image process a front image or a rear image. For example, the image recognition unit 120 may use a pattern recognition scheme for lane recognition, vehicle recognition, vehicle license plate recognition, and the like. As an example, the pattern recognition scheme may use at least one scheme of extracting a feature among a Haar scheme, a Wavelet scheme, and a histrogram of oriented gradient (HOG) scheme. As another example, the pattern recognition scheme may also use at least one classification scheme among a support vector machine (SVM) scheme, a neural network scheme, an Adaptive Boosting (Adaboost) scheme. Alternatively, the image recognition unit 120 may use a combination of the aforementioned pattern recognition schemes for performing pattern recognition.

The image recognition unit 120 may recognize a plurality of lanes, a lane driven by a vehicle, a leading vehicle, for example a leading vehicle located directly in front of the vehicle, and a license plate of the leading vehicle, in a sequential manner. The image recognition unit 120 may output the recognized information to the determining and control unit 170. The image recognition unit 120 may continuously trace the recognized leading vehicle, or the license plate of the leading vehicle, through a front image outputted from the camera unit 110. Also, the image recognition unit 120 may recognize a lane change or a lane deviation of a vehicle of a driver, a leading vehicle, or a rear vehicle.

The image recognition unit 120 may extract a registration number from a license plate included in a front image. The image recognition unit 120 may output the extracted registration number to the determining and control unit 170.

The image recognition unit 120 may use the license plate included in the front image to calculate a distance between a vehicle and a leading vehicle being driven in front of the vehicle. For example, the image recognition unit 120 may calculate a distance between the two vehicles through verifying a number of pixels of the license plate included in the front image. In particular, a size of the license plate in an image may vary based on a distance from the leading vehicle or the rear vehicle. When the distance from the vehicle decreases, the image recognition unit 120 may verify that the size of the license plate in the image may increase. When the distance from the vehicle increases, the image recognition unit 120 may verify that the size of the license plate in the image may decrease. The license plate may have a consistent size through being standardized. Accordingly, the image recognition unit 120 may calculate a distance between two vehicles, using a change of the size of the license plate included in the image. The image recognition unit 120 may calculate the distance between two vehicles in real time.

The image recognition unit 120 may output the calculated distance to the determining and control unit 170. Also, the image recognition unit 120 may allow the determining and control unit 170 to calculate a distance between two vehicles, through providing license plate size information to the determining and control unit 170.

The wireless communication unit 130 may set a communication path for communicating with another vehicle, and transmit and receive data through the set path. The wireless communication unit 130 may communicate directly with a device of another vehicle able to communicate wirelessly without a base station or an access point (AP). To this end, the wireless communication unit 130 may utilize a mobile ad-hoc network (MANET) or a Zigbee sensor network. The wireless communication unit 130 may further generate an additional data channel for secure communication with a leading vehicle.

The wireless communication unit 130 may receive accident prevention information transmitted from an adjacent vehicle for preventing an accident through communication with another vehicle. For example, the accident prevention information may include a leading vehicle identifier, a speed of a leading vehicle, a time, an alert signal, and the like. Here, the leading vehicle identifier may refer to information for identifying a leading vehicle, and the speed of the leading vehicle may refer to a driving speed of the leading vehicle. The time may refer to a time at which the speed of the leading vehicle is measured, and the alert signal may refer to an alert signal for a risk of an accident.

The wireless communication unit 130 may receive the accident prevention information of other leading vehicles located at a front of a leading vehicle from the leading vehicle located immediately in front of the vehicle. Alternatively, the wireless communication unit 130 may receive the accident prevention information of the other leading vehicles through directly communicating with the other leading vehicles, aside from the leading vehicle located immediately in front of the vehicle.

The wireless communication unit 130 may output the received accident prevention information to the determining and control unit 170.

The speed detection unit 140 may detect a speed of a vehicle currently being driven. The speed detection unit 140 may output the detected speed of the vehicle to the determining and control unit 170.

The GPS module unit 150 may measure a current time, using a received signal through a satellite. The GPS module unit 150 may output the measured time to the determining and control unit 170. Also, the GPS module unit 150 may measure a location of a vehicle, and output the measured location of the vehicle to the determining and control unit 170.

The memory 160 may store a driving program, and the like, for driving the vehicle accident prevention apparatus 100. Also, the memory 160 may store data generated during an operation of the vehicle accident prevention apparatus 100.

The memory 160 may store a registration number of a license plate and a vehicle identifier through mapping. Here, the vehicle identifier may correspond to a one-on-one relationship with the vehicle registration number. The vehicle identifier may be used for communicating with a vehicle corresponding to a vehicle identifier, as an identification (ID).

The determining and control unit 170 may receive a leading vehicle registration number extracted from the image recognition unit 120, and the accident prevention information including the leading vehicle identifier received via the wireless communication unit 130. The determining and control unit 170 may identify a leading vehicle or a rear vehicle through comparing a vehicle registration number to a vehicle identifier stored in the memory 130.

The determining and control unit 170 may receive the accident prevention information about a leading vehicle through the wireless communication unit 130, using the leading vehicle identifier.

The determining and control unit 170 may perform an accident prevention determination through comparing the speed of the vehicle outputted from the speed detection unit 140 to the speed of the leading vehicle. In this instance, the determining and control unit 170 may compare the speed of the vehicle outputted from the speed detection unit 140 to the speed of the leading vehicle, using the speed of the leading vehicle measured at a time identical to a time measured in the GPS module unit 150. In particular, the determining and control unit 170 may compare the speed of the leading vehicle to a speed of a vehicle of a driver at an identical point of time. As an example, the determining and control unit 170 may perform an accident prevention determination, based on a driving speed of the vehicle of the driver with respect to an acceleration speed state, a reduction speed state, and a constant speed state of the leading vehicle. Also, the determining and control unit 170 may generate a variety of information corresponding to a result of the determination.

The determining and control unit 170 may perform the accident prevention determination between a vehicle and a leading vehicle being driven in front of the vehicle through a distance between the vehicle and the leading vehicle obtained through the image recognition unit 120. The determining and control unit 170 may predict a risk of an accident more accurately through comparing the speed of the vehicle currently being driven to the speed of the leading vehicle, based on a distance between the vehicle currently being driven and the leading vehicle.

When information about other leading vehicles located immediately in front of the leading vehicle is received, the determining and control unit 170 may perform the accident prevention determination including the leading vehicle of a current lane and the other leading vehicles located in front of the leading vehicle.

Here, the determining and control unit 170 may perform the accident prevention determination through comparing a speed of a leading vehicle or another leading vehicle, for example, a vehicle further ahead of the leading vehicle to a reference speed. The determining and control unit 170 may predict an accident through the accident prevention determination when a range of the reference speed is exceeded, for example, when in a resting state, lower than a lowest driving speed state, and the like.

The determining and control unit 170 may generate information on an arrangement of vehicles of a lane of a vehicle currently being driven when the determining and control unit 170 additionally receives information about other leading vehicles located in front of the leading vehicle. Here, the determining and control unit 170 may use a location of a vehicle outputted from the GPS module unit 150 for generating the information on the arrangement of vehicles. The determining and control unit 170 may perform an accident prevention determination between leading vehicles and between a leading vehicle and a vehicle of a driver. When a detected lane is changed, the determining and control unit 170 may re-recognize a leading vehicle in the changed lane, and re-generate the information on the arrangement of vehicles.

The determining and control unit 170 may output a signal generated based on the accident prevention determination to the display unit 180. Also, the determining and control unit 170 may output information on an arrangement of vehicles, and the like, to the display unit 180. The determining and control unit 170 may output, to the driver control unit 190, an alert signal notifying a risk of an accident based on the accident prevention determination or a driving control signal based on the accident prevention determination.

The determining and control unit 170 may generate accident prevention information for determining the accident prevention in a rear vehicle, and transmit the accident prevention information via the wireless communication unit 130. In this instance, the accident prevention information may include a speed of a vehicle, a time of a vehicle, a vehicle identifier, alert information, and the like. The determining and control unit 170 may generate the accident prevention information, using information collected from a vehicle of a driver to generate the accident prevention information.

The determining and control unit 170 may provide, to the rear vehicle, the accident prevention information received from the leading vehicle, along with the accident prevention information of the vehicle of the driver. Transitively, the determining and control unit 170 may allow the rear vehicle to perform the accident prevention determination, with information about leading vehicles of the rear vehicle also being considered.

As an example, the determining and control unit 170 may perform an accident prevention determination with respect to the rear vehicle, similar to an instance in which the accident prevention determination is performed with respect to the leading vehicle described in the example in the foregoing.

The display unit 180 may display information, based on the accident prevention determination outputted from the determining and control unit 170. Also, the display unit 180 may display information on an arrangement of vehicles of the leading vehicles located in front of the vehicle of the driver in a current lane.

The driver control unit 190 may control a driving device in response to a driving control signal. The driver control unit 190 may control a driving operation of a vehicle through controlling the driving device in an accident prevention situation. Accordingly, the driver control unit 190 may prevent an accident between vehicles through direct control based on the driving control signal.

The driver control unit 190 may include a speaker for notifying a driver of an alert signal based on the accident prevention determination. Also, the driver control unit 190 may include an electronic control unit (ECU), a braking device control unit, a safety belt, and an air bag control unit that are electrically connected, and control based on the driving control signal.

The vehicle accident prevention apparatus 100 may perform an accident prevention determination, based on the speed information of the leading vehicle received from the leading vehicle, and minimize an error probability of determining the accident prevention with respect to the leading vehicle.

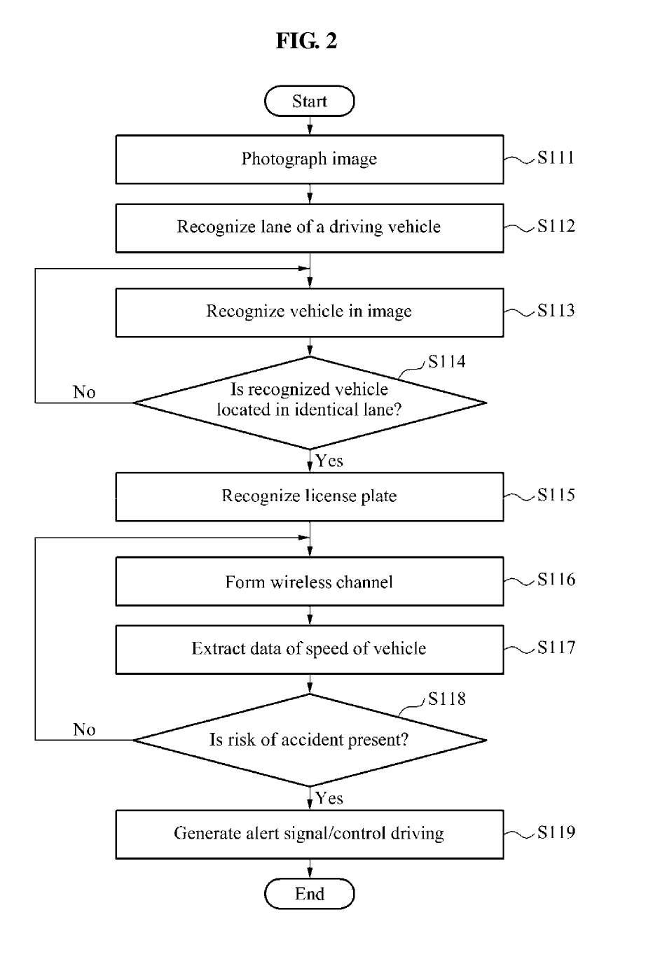

FIG. 2 is a diagram illustrating an operation of preventing a vehicle accident in a vehicle accident prevention apparatus according to example embodiments.

Referring to FIG. 2, in operation S111, the camera unit 110 may photograph a front image or a rear image. The camera unit 110 may output the photographed image to the image recognition unit 120.

In operation S112, the image recognition unit 120 may recognize a lane in which a driver of a vehicle is driving from an image.

In operation S113, the image recognition unit 120 may recognize a vehicle in an image, for example, a leading vehicle or a rear vehicle.

In operation S114, the image recognition unit 120 may determine whether the recognized vehicle located in an identical lane.

As a result of the determination in operation S114, the image recognition unit 120 may proceed to operation S113 when the recognized vehicle is determined not to be located in the identical lane.

As a result of the determination in operation S114, the image recognition unit 120 may proceed to operation S115 when the recognized vehicle is determined to be located in the identical lane.

In operation S115, the image recognition unit 120 may recognize a license plate with respect to a vehicle located in the identical lane. The image recognition unit 120 may recognize the license plate, using a pattern recognition scheme. The image recognition unit 120 may calculate a leading vehicle registration number and a distance between the vehicle of the driver and the leading vehicle, through recognizing the license plate. The image recognition unit 120 may output the vehicle registration number and the distance between the vehicle of the driver and the leading vehicle to the determining and control unit 170.

In operation S116, the wireless communication unit 130 may form a wireless channel with the leading vehicle. To this end, the wireless communication unit 130 may receive a wireless signal from vehicles in a vicinity. The wireless communication unit 130 may extract vehicle identifier information included in a wireless signal, and when the vehicle identifier information is verified to be a leading vehicle located in the current lane by the determining and control unit 130, may form a wireless channel enabling data communication with a corresponding leading vehicle. The wireless communication unit 130 may receive accident prevention information, for example, a leading vehicle identifier, a speed of a leading vehicle, a time for measuring the speed of the leading vehicle, an accident alert signal for a risk of an accident, and the like, via the wireless channel.

The wireless communication unit 130 may additionally configure a wireless channel for receiving information about at least two leading vehicles located in an identical lane.

In operation S117, the speed detection unit 140 may extract a speed of a vehicle. Also, the GPS module 150 may extract a time. The speed detection unit 140 and the GPS module unit 150 may output a speed and a time to the determining and control unit 170, respectively. The determining and control unit 170 may verify the speed of the vehicle extracted at a predetermined point of time.

In operation S118, the determining and control unit 170 may verify whether a risk of an accident exists, through a speed comparison. The determining and control unit 170 may perform an accident prevention determination through comparing the speed of the leading vehicle received via the wireless communication unit 130 to the speed of the vehicle detected by the speed detection unit 140. The determining and control unit 170 may compare the speeds at an identical point of time, using a point of time at which the speed of the vehicle is measured. The determining and control unit 170 may determine whether a driving speed of the leading vehicle is high or low through the speed comparison. In particular, the determining and control unit 170 may determine whether the leading vehicle violates a maximum speed or a minimum speed for a particular road, such as a highway. The determining and control unit 170 may receive highway entrance information via a transmitter provided at a tollgate, and the like, of a highway to recognize information for a road. In particular, the determining and control unit 170 may receive entrance information via the wireless communication unit 130. Transitively, the determining and control unit 170 may determine whether the vehicle of the driver is driven on the highway or another road, from the entrance information and exit information.

The determining and control unit 170 may output information generated based on the accident prevention determination, via the display unit 180.

As a result of the determination in operation S118, the determining and control unit 170 may proceed to S116 when a risk of an accident is absent. In operation S116, the determining and control unit 170 may continuously determine a risk of an accident by continuously receiving a speed of a leading vehicle via the wireless communication unit 130.

As a result of the determination in operation S118, the determining and control unit 170 may proceed to S119 when a risk of an accident is present.

In operation S119, the determining and control unit 170 may generate a driving control signal for generating an alert signal based on a risk of an accident or a driving control signal for controlling a driving device of a vehicle. The determining and control unit 170 may output the driving control signal to the driver control unit 190. The determining and control unit 170 may reduce or stop a driving speed of a vehicle via the driving device, based on a risk of an accident.

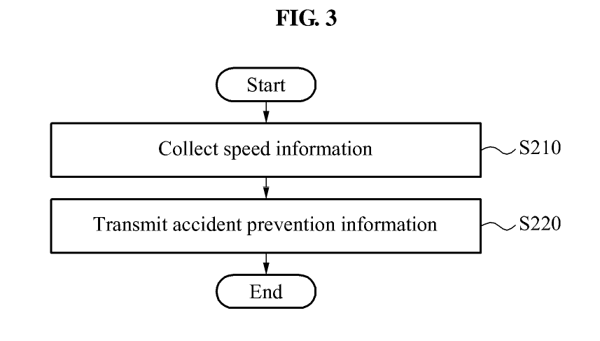

FIG. 3 is a diagram illustrating an operation of transmitting accident prevention information for preventing a vehicle accident in a vehicle accident prevention apparatus according to example embodiments.

Referring to FIG. 3, in operation S210, the determining and control unit 170 may collect a speed of a vehicle from the speed detection unit 140.

The speed detection unit 140 may measure a speed of a vehicle of a driver. The speed detection unit 140 may output a speed of the vehicle of the driver to the determining and control unit 170.

In operation S220, the determining and control unit 170 may transmit the accident prevention information including collected speed information via the wireless communication unit 130. Here, the accident prevention information may include an identifier of a current vehicle. Also, the accident prevention information may transmit time information based on collected speed information and an alert signal based on a risk of an accident. The wireless communication unit 130 may transmit the accident prevention information to vehicles in the vicinity, in a single bundle of data.

As another example, an operation of FIG. 3 may refer to an operation of transmitting information of determining accident prevention to a rear vehicle located in behind the vehicle.

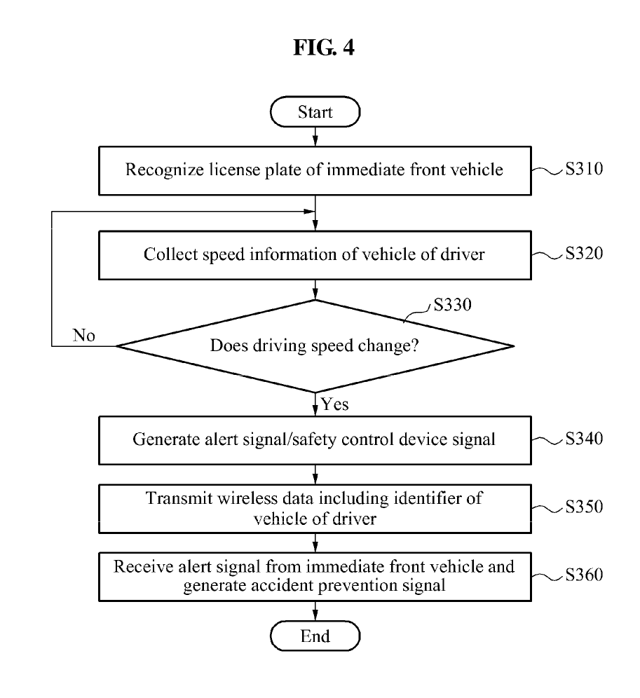

FIG. 4 is a diagram illustrating an operation of transmitting accident prevention information for preventing an accident with another vehicle in a vehicle accident prevention apparatus according to example embodiments.

Referring to FIG. 4, in operation S310, the image recognition unit 120 may recognize a license plate of a leading vehicle from an image photographed through a camera. The image recognition unit 120 may output leading vehicle information recognized from the license plate to the determining and control unit 170.

In operation S320, the speed detection unit 140 may detect a speed of a vehicle. The speed detection unit 140 may output the detected speed to the determining and control unit 170. In this instance, the GPS module unit 150 may measure current time information. The GPS module unit 140 may output a current time to the determining and control unit 170. The determining and control unit 170 may collect a speed of a vehicle and a time with respect to the vehicle of the driver.

In operation S330, the determining and control unit 170 may detect a speed change of the vehicle of the driver, and determine whether a current driving speed is changed. The determining and control unit 170 may detect a drastic change of a driving speed, based on an accident-risk situation.

As a result of the determination in operation S330, the determining and control unit 170 may proceed to S320 when the determining and control unit 170 fails to detect the drastic change of the driving speed based on the risk of an accident.

As a result of the determination in operation S330, the determining and control unit 170 may proceed to S320 when the determining control unit 170 detects the change of the driving speed based on the risk of an accident.

In operation S340, the determining and control unit 170 may generate an alert signal for a vehicle accident prevention.

In operation S350, the determining and control unit 170 may transmit an accident prevention signal including identification information of a vehicle of a driver via the wireless communication unit 130. In this instance, the determining and control unit 170 may generate accident prevention information including a time corresponding to a speed. The determining and control unit 170 may transmit an identifier of a vehicle of a driver, along with the accident prevention information. The determining and control unit 170 may transmit the accident prevention information received from the leading vehicle, along with the accident prevention signal.

In operation S360, when the determining and control unit 170 receives an alert signal based on a change of a current driving speed from a leading vehicle, the determining and control unit 170 may transmit an accident prevention signal including an alert signal of a corresponding leading vehicle, via the wireless communication unit 130. Also, the determining and control unit 170 may generate a driving signal for controlling a driving speed of a vehicle of a driver, corresponding to the alert signal.

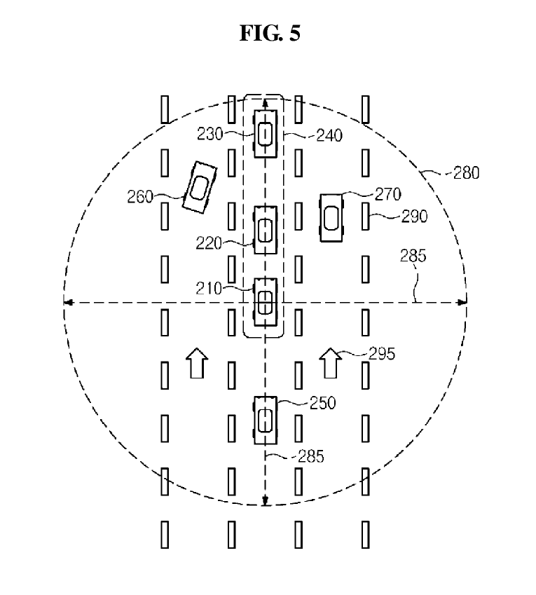

FIG. 5 is a diagram illustrating a wireless communication area of a vehicle to which a vehicle accident prevention apparatus is attached according to example embodiments.

Referring to FIG. 5, a vehicle 210 of a driver in which a vehicle accident prevention apparatus is provided may communicate with vehicles located in a predetermined communication area 280, based on a wireless function of the wireless communication unit 310. In the communication area 280, a radius 285 may range from a few kilometers to hundreds of kilometers. A forward direction 295 of vehicles being driven in a current lane 290 is illustrated as an upward direction in the drawing.

Accordingly, a leading vehicle 220 and a leading vehicle 230 located in front of the vehicle 210 of the driver are illustrated. Also, a rear vehicle 250 located in a rear of the vehicle 210 of the driver is illustrated.

The vehicle 210 of the driver may perform an accident prevention determination, using data that communicates with other vehicles in the communication area 280. For example, the vehicle 210 of the driver may prevent an accident with vehicles, using speed information received wirelessly with respect to the leading vehicle 220 or the rear vehicle 250.

The vehicle 210 of the driver may generate information 240 on an arrangement of vehicles, via the vehicle accident prevention apparatus 100.

The vehicle accident prevention apparatus 100 may control the vehicle 210 of the driver not to avoid a forward collision, a rear-end collision, or a multiple-vehicle collision with a leading vehicle or a rear vehicle. In particular, the vehicle accident prevention apparatus 100 may minimize a cause of an error in collecting data for determining accident prevention through recognizing and selecting information of a leading vehicle.

The vehicle accident prevention apparatus 100 may verify information on an arrangement of vehicles about leading vehicles currently being driven in a lane when the vehicle accident prevention apparatus 100 collects a leading vehicle identifier or leading vehicle speed information of another leading vehicle located in front of a leading vehicle, via the leading vehicle. Transitively, the vehicle accident prevention apparatus 100 may increase a prediction probability of performing an accident prevention determination.

Also, the vehicle accident prevention apparatus 100 may perform an accident prevention determination efficiently through transmitting and receiving speed information of the leading vehicle and distance information between the vehicle of the driver and the leading vehicle, along with the speed information and the distance information of other vehicles.

### INDUSTRIAL APPLICABILITY

A vehicle accident prevention apparatus may be utilized for minimizing an error probability, based on an accident prevention determination as the vehicle accident prevention apparatus obtains relative speed information of a leading vehicle.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A vehicle accident prevention apparatus, comprising:
a camera unit to photograph a front image of a vehicle;
an image recognition unit to recognize a leading vehicle registration number from a license plate of a leading vehicle located at a front of the vehicle, through image processing of the front image;
a wireless communication unit to receive accident prevention information including a leading vehicle identifier and a speed of the leading vehicle, through communicating with the leading vehicle;
a speed detection unit to detect a speed of the vehicle; and
a determining and control unit to identify the leading vehicle, through matching the leading vehicle registration number and the leading vehicle identifier, and generate a control signal for preventing an accident with the leading vehicle through comparing the speed of the vehicle to the speed of the leading vehicle.

2. The vehicle accident prevention apparatus of claim 1, further comprising:
a global position system (GPS) module unit to measure a time of the vehicle.

3. The vehicle accident prevention apparatus of claim 2, wherein the determining and control unit receives the time of the leading vehicle through the wireless communication unit, and compares the speed of the vehicle to the speed of the leading vehicle at a point of time at which a time of the leading vehicle and a time of the vehicle match.

4. The vehicle accident prevention apparatus of claim 1, wherein the image recognition unit recognizes the license plate of the leading vehicle through the photographed image, and generates distance information between the leading vehicle and the vehicle through a number of pixels of the recognized license plate.

5. The vehicle accident prevention apparatus of claim 4, wherein the determining and control unit generates the control signal, using the generated distance information.

6. The vehicle accident prevention apparatus of claim 1, further comprising:
a driver control unit to control a braking device of the vehicle through receiving the control signal.

7. The vehicle accident prevention apparatus of claim 1, wherein the driver control unit receives the control signal, and emit an alert signal to a driver of the vehicle.

8. The vehicle accident prevention apparatus of claim 1, wherein the wireless communication unit receives an alert signal for preventing the accident from the leading vehicle.

9. The vehicle accident prevention apparatus of claim 8, wherein the determining and control unit generates a control signal for preventing an accident with the leading vehicle, based on the alert signal of the leading vehicle.

10. The vehicle accident prevention apparatus of claim 1, wherein the determining and control unit receives accident prevention information from the leading vehicle or other vehicles being driven in front of the vehicle, and generates information on an arrangement of vehicles in a vicinity of the vehicle, based on the accident prevention information.

11. The vehicle accident prevention apparatus of claim 1, wherein the wireless communication unit sets a communication channel for exclusive communication with the leading vehicle.

12. The vehicle accident prevention apparatus of claim 1, wherein the determining and control unit generates information on an arrangement of vehicles of a lane in which a vehicle is being driven when information about other leading vehicles located in front of the leading vehicle, in a lane in which the leading vehicle is being driven, and outputs the generated information on the arrangement of vehicles to a display device.

13. A vehicle accident prevention method, comprising:
recognizing a license plate of a leading vehicle included in an image photographing a front of a vehicle;
receiving a leading vehicle identifier and a speed of the leading vehicle from the leading vehicle;
identifying the leading vehicle through matching a leading vehicle registration number obtained from the license plate of the leading vehicle and the leading vehicle identifier;
measuring a speed of the vehicle; and
generating a control signal for preventing an accident with the leading vehicle through comparing the speed of the leading vehicle to the speed of the vehicle.

14. The vehicle accident prevention method of claim 13, wherein the recognizing of the license plate of the leading vehicle comprises:
recognizing a lane included in the photographed image;
recognizing a leading vehicle in the lane; and
recognizing a license plate of a vehicle when the recognized leading vehicle is a vehicle located in a lane identical to a lane in which a vehicle is currently being driven.

15. The vehicle accident prevention method of claim 13, further comprising:
displaying an accident alert state, based on the control signal.

16. The vehicle accident prevention method of claim 13, further comprising:
controlling a braking device of the vehicle, based on the control signal.

17. The vehicle accident prevention method of claim 13, further comprising:
receiving information about other leading vehicles located in a lane identical to a lane of the leading vehicle;
generating information on an arrangement of vehicles including the leading vehicle and the other leading vehicles; and
displaying the information on the arrangement of vehicles.
